(19) United States
(12) Patent Application Publication
(10) Pub. No.: US 2006/0020995 A1
(43) Pub. Date: Jan. 26, 2006

(54) Fast channel change in digital media systems

(75) Inventors: Robin L. Opie, Newtown Square, PA (US); Charles L. Compton, Bryn Mawr, PA (US); Weidong Mao, West Windsor, NJ (US)

Correspondence Address: BROOKS KUSHMAN P.C., 1000 TOWN CENTER, TWENTY-SECOND FLOOR, SOUTHFIELD, MI, 48075, US

(73) Assignee: Comcast Cable Communications, LLC, Philadelphia, PA (US)

(21) Appl. No.: 10/895,234

(22) Filed: Jul. 20, 2004

(51) Int. Cl. H04N 7/173; H04N 7/16

(52) U.S. Cl. 725/117; 725/131; 725/151; 725/147

(57) ABSTRACT

A system for processing digital media streams includes a headend, a network, at least one set top box (STB), and at least one receiving device. The headend may be configured to generate the digital media streams. The network may be in communication with the headend and configured to receive the digital media streams. The at least one STB may be in communication with the network and configured to receive the digital media streams and present at least one of the digital media streams or a decoded version of at least one of the digital media streams. The at least one receiving device may be in communication with a respective at least one STB to receive at least one of the digital media streams. At least one of the headend, the at least one STB, and the receiving device comprises a media processing sub-system configured to provide for substantially immediately displaying a user viewable image on a display screen of the receiving device during channel changing.

### BACKGROUND OF THE INVENTION

1. Field of the Invention

The present invention relates to a system and a method for fast channel change in digital media systems.

2. Background Art

Compressed digital video media stream services such as high definition television (HDTV) service are available from cable (and satellite) television (TV) service providers to the majority of homes, shops, taverns, businesses, etc. (i.e., cable television subscribers, customers, clients, viewers, etc.) served by the television service providers. A media stream is transmitted (i.e., sent, presented, provided, broadcast, etc.) including one or more encoded video streams and respective audio streams (i.e., media streams). The streams are typically transmitted from a headend, through a network (or wirelessly) the viewers location. The network can be a cable network, a satellite distribution system, etc. In one example, a set top box (STB) at the customer location receives the media stream and is coupled to one (or more) viewing devices such as a television, a monitor, and the like In another example, the STB may be eliminated and the receiving device (generally a viewing device) is coupled directly to the network. Each media stream is related to a channel (e.g., a particular user selected-broadcast channel) that is viewed on a viewing device by the customers. The client generally changes the channel (i.e., the stream) that is viewed by switching channels either in the STB or in the viewing device.

Digital media (e.g., video) streams are typically broadcast using a Motion Picture Expert Group (MPEG) format (e.g., MPEG-2, MPEG-4, etc.), or other appropriate format such as Windows Media 9, Real Media, and the like which includes several types of frames (e.g., I, P, and B frames)) that are used to generate viewing screen images. The frames are used to generate the pictures that are viewed. The picture generation process is occasionally reset to reduce or eliminate errors that can accumulate in the picture generation process.

When the channel is changed (switched) rapidly on a conventional digital video system, for instance, during user (viewer) “channel surfing” or browsing, a delay in displaying a proper image can occur while the STB (or receiving device) waits for an appropriate set of frames that are sufficient to generate a picture for viewing to be received. In some cases, a black screen can be displayed during the waiting period. In contrast, conventional analog television broadcast systems provide a substantially instantaneously viewable picture during “channel surfing.” Customers who are familiar with conventional analog television systems can find the brief black viewing screen image that can be sometimes encountered on digital television systems during rapid channel changing disconcerting or annoying. The brief black image may have a negative impact on the customer perception of digital television service and on the digital television service provider.

Thus, it would be desirable to have a system and a method for fast channel change in digital media systems that reduces or eliminates the brief black screen images that are sometimes encountered on digital television systems during the channel changing process.

### SUMMARY OF THE INVENTION

The present invention generally provides new and innovative systems and techniques for fast channel changes in digital media systems that reduces or eliminates the brief black screen images that are sometimes encountered on digital television systems during the channel changing process.

According to the present invention, a system for processing digital media streams is provided. The system comprises a headend, a network, at least one set top box (STB), and at least one receiving device. The headend may be configured to generate the digital media streams. The network may be in communication with the headend and configured to receive the digital media streams. The at least one STB may be in communication with the network and configured to receive the digital media streams and present at least one of the digital media streams and a decoded version of at least one of the digital media streams to a receiving device. The at least one receiving device may be in communication with a respective at least one STB to receive at least one of the digital media streams. At least one of the headend, the at least one STB, and the receiving device comprises a media processing sub-system configured to receive at least one of the digital media streams and to provide for substantially immediately displaying a user viewable image on a display screen of the receiving device during channel changing.

Also according to the present invention, a method for processing digital media streams is provided. The method comprises generating digital media streams at a headend, coupling a network to the headend and receiving the digital media streams at the network, coupling at least one set top box (STB) to the network and receiving the digital media streams at the at least one STB, and coupling at least one respective receiving device configured to receive at least one of the digital media streams or a decoded version of at least one of the digital media streams to the at least one STB. At least one of the headend, the at least one STB, and the at least one receiving device comprises a media processing sub-system configured to provide for substantially immediately displaying a user viewable image on a display screen of the receiving device during channel changing.

Further, according to the present invention, for use in a system for multi-stream digital media processing, a media processing sub-system is provided. The sub-system comprises a media processor and a multi-rate media decoding processor. The media processor may be configured to generate and present digital media streams. At least one of the media streams comprises a group of pictures (GOP) and at least one I frame. At least one other of the media streams is a media stream that provides a substantially immediately viewable image on a display screen of a receiving device during channel changing. The multi-rate media decoding processor may be configured to decode the MPEG media stream and the at least one other media stream.

The above features, and other features and advantages of the present invention are readily apparent from the following detailed descriptions thereof when taken in connection with the accompanying drawings.

### BRIEF DESCRIPTION OF THE DRAWINGS

FIGS. 1(a-b) are diagrams of media stream processors of the present invention;

FIGS. 2(a-b) are diagrams of multi-rate media stream decoders of the present invention; and

FIGS. 3(a-d) are diagrams of media processing and delivery systems implementing the present invention.

### DETAILED DESCRIPTION OF THE PREFERRED EMBODIMENT(S)

With reference to the Figures, the preferred embodiments of the present invention will now be described in detail. In one example, the present invention may be implemented in connection with a cable television transmission and reception system. In another example, the present invention may be implemented in connection with a satellite (i.e., “dish”) broadcast television transmission and reception system (not shown). However, the present invention may be implemented in connection with any appropriate media stream transmission and reception system to meet the design criteria of a particular application.

In the description below, these terms may be defined as follows:
Anycast: A media stream transmission via a network between a single sender and the nearest of a group of receivers that are connected (or coupled) to the network.
B frames: Bi-directional predictive frames that are used in MPEG-2 (and other) coded digital video streams. B frames are generated by determining the difference between previous and subsequent frames in a video media image sequence. B frames only contain predictive information, and do not comprise a complete video image. B frames contain less data and use less space (e.g., storage) than I frames.
Broadcasting: Presenting (sending) a media stream to all of the receivers that are connected (or coupled) to a network.
‘Channel surfing’: User is rapidly changing channels that are to be viewed, generally such that when digital television is being watched, the viewing screen momentarily displays a black image instead of a picture of what is being broadcast on the channel that is tuned.
Data Over Cable Service Interface Specifications: (DOCSIS) DOCSIS is a standard interface for cable modems, the devices that handle incoming and outgoing data signals between a cable TV operator and a personal or business computer or television set. Although the term DOCSIS continues to be used, the standard is now being used to certify the products of cable modem makers. DOCSIS specifies modulation schemes and the protocol for exchanging bidirectional signals over cable.
DSG: DOCSIS Set Top Gateway
Frame: One image of a sequence of images. In one example (video streams), a frame captures and displays all of the pixels and all of the lines that comprise an image.
Group Of Pictures (GOP): In a media stream that is in a compressed digital video format, the GOP is a group of frames that is presented between successive I frames, and the GOP comprises P frames, B frames, or both P frames and B frames. For television transmission, the GOP is typically 12 frames. For example, a new sequence that starts with an I frame may be transmitted when a substantial change in the image to be displayed is encountered such as at a cut or channel change. SMPTE time code data may be included with the first picture in a GOP.
I frames: Intraframe (i.e., media coding within a frame of a media signal) frames used in, for example, MPEG-2 (and other) coded digital video streams, and which contain data to generate a whole picture. I frames comprise information from only one frame. Discrete cosine transforming (DCT) is used to compress the information that is contained in I frames.
Interframe coding: Data compression that is performed in response to differences that are determined between actual data and predicted data. Predicted data is typically generated in response to past and future reference frames.
Motion Pictures Expert Group (MPEG): MPEG (e.g., MPEG-1, MPEG-2, MPEG-4, etc.) is a series of compression standards for moving images that was created and developed by an international group of industry experts.
Multicast: Transmission of a single media stream to a selected (or predetermined) group of receivers (e.g., transmitting a live video/audio stream to multiple receivers substantially simultaneously).
Narrowcast: Transmission of dedicated media stream to each user.
P frames: Frames that contain only predictive information, and not complete picture information. P frames contain substantially less data than I frames. P frames are generated via analysis of the difference between the current frame and the previous frame. To generate a complete picture that corresponds to a particular P frame, the portion of the GOP that is proceeding the P frame needs to be decoded. P frames may provide lower system media stream rates.
Set Top Box: (STB, also Decoder, Receiver, Tuner, Transceiver). A unit similar to cable boxes. The STB is capable of receiving and decoding DTV broadcasts. A STB typically converts and displays transmissions from one frequency or format such as analog cable, digital cable, satellite broadcast, digital television, etc. to a standard frequency (such as channel 3 or 4) for display on a television, monitor, and the like. A DTV ‘Certified’ STB can receive all (i.e., 18) ATSC DTV formats, (including HDTV) and provide a displayable picture to a receiving device such as a television or monitor. Some STBs are implemented with two-way capability such that a user can interface to and communicate with the provider headend (e.g., via a DSG). STB functionality can also be integrated into other devices including personal computers, television sets, digital video recorders (DVRs), etc.
SMPTE: Society of Motion Picture and Television Engineers. A professional organization that sets American television standards. Also may refer to a color difference video format that uses a variation of Y, R-Y, and B-Y signals.
Unicast: A media stream transmission between a single sender and a single receiver via a network.

The present invention generally provides new and innovative systems and techniques for fast channel changes in digital video systems that reduce or eliminate time duration of the brief black screen image that is sometimes encountered on digital television systems during the channel changing process. The present invention generally provides for substantially (i.e., approximately, essentially, etc.) immediately displaying a user viewable image on a display screen of a media stream receiving device during channel changing. In one example, the reduced time duration of the present invention yields a black screen image display time that is less than 5 milliseconds. In another example, the reduced time duration of the present invention yields a black screen image display time that is less than 10 milliseconds. However, the reduced time duration of the present invention generally yields a black screen image display time that meets the design criteria of a particular application (e.g., a predetermined time).

In various examples, the present invention may provide for at least one of: insertion of at least one I frame into a unicast transmission, sending at least one I frame on demand (i.e., in response to a user command) via Internet Protocol or other networking technologies (i.e., in connection with a switched broadcast), multicasting a stream of I frames that a STB can “grab” (i.e., receive and decode) on known multicast addresses, constantly maintaining up-to-date I frames in the headend, transmitting ‘burst’ frames (e.g., frames that are broadcast at a higher than normal rate) on unicast streams to ‘catch up’ the decoder, and (in connection with a unicast transmission) providing for the viewing devices to be a GOP off and starting the display that is viewed with an I frame.

In one example, the present invention may provide for additional information to be transmitted (i.e., sent, presented, provided, broadcast, etc.) in connection with the conventional digital video stream including one or more signals (e.g., media streams) that provide for displaying a picture (instead of a black screen image) on a receiving (e.g., viewing) device more quickly than conventional approaches display a viewable image.

The present invention may reduce the channel change time in digital video systems and provide methods for allowing unicast video streams to synchronize timing with reference broadcast streams and multicast video streams. Channel change times can have a significant impact on user experience. Synchronizing unicast streams to broadcast streams and multicast video streams generally lowers the bandwidth and processing requirements associated with providing the streams.

Media service providers that implement the present invention may significantly improve respective competitive positions by allowing faster program changes/channel changes. In addition, the present invention may provide for easier movement (i.e., upgrade, transition, etc.) of analog service customers to a digital platform. The digital platform may provide consistent picture quality, spectral efficiency, and advanced services delivery when compared to conventional analog services. The media service provider may leverage the ‘shared’ nature of the delivery system architecture to minimize content streaming costs and bandwidth requirements by providing a system and a method for leveraging broadcast and mullticast capabilities.

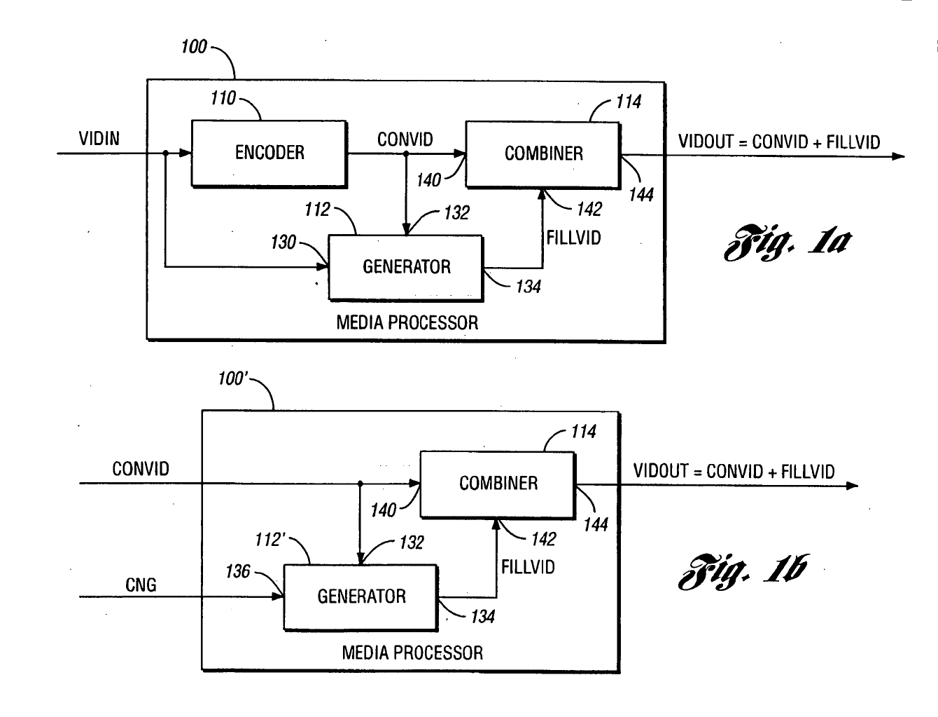

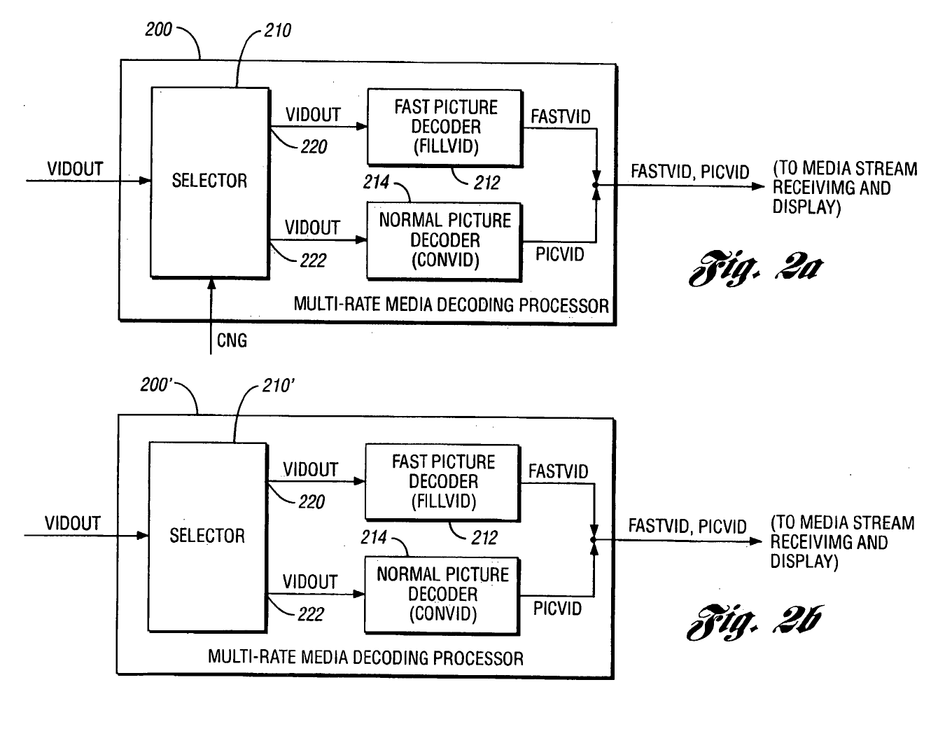

Referring to FIG. 1a, a diagram illustrating a media processor 100 in accordance with the present invention is shown. The processor 100 generally has a first input that receives a media stream (e.g., VIDIN) and an output that presents a digital media stream (e.g., VIDOUT). The stream VIDIN generally comprises one or more media signals or streams (e.g., video, video plus audio, standard broadcast, digital media streams, etc.).

The stream VIDOUT generally comprises an encoded and compressed digital media stream having one or more portions (e.g., segments, components, sections, etc.). At least one of the portions of the stream VIDOUT (e.g., a video stream CONVID) generally comprises a digital video stream that is implemented having a Motion Picture Expert Group (MPEG) format (e.g., MPEG-2, MPEG-4, etc.), or other appropriate format such as Windows Media 9, Real Media, and the like which includes several types of frames (e.g., I, P, and B frames) that are used to generate viewing screen images. However, any appropriate media stream format (e.g., a media stream that comprises a group of pictures (GOP) and at least one I frame) may be implemented to meet the design criteria of a particular application.

Another portion of the media stream VIDOUT (e.g., FILLVID) is generally configured to provide for displaying a picture (instead of a black screen image) on a receiving (e.g., viewing) device more quickly (e.g., substantially immediately) than conventional approaches. The media stream FILLVID may reduce or eliminate the temporary black image that can appear on the viewing device screen when viewing channels are rapidly changed when conventional approaches are used.

The processor 100 generally comprises an encoder 110, a generator 112, and a combiner 114. The encoder 110 may have an input that may receive the media stream VIDIN and an output that may present the media stream CONVID. The encoder 110 generally encodes (e.g., transforms, compresses, etc.) the stream VIDIN to generate the stream CONVID.

The generator 112 may have an input 130 that may receive the stream VIDIN, an input 132 that may receive the stream CONVID, and an output 134 that may present a stream (e.g., the media stream FILLVID). The stream FILLVID is generally implemented as a stream that provides a viewing (or receiving) device information to display a picture image more rapidly than a conventional digital video stream (e.g., a conventional group of pictures (GOP)) during a channel change operation. In one example, the stream FILLVID may implemented as a selectively transmitted portion of the stream VIDOUT. In another example, the stream FILLVID may be continuously generated and transmitted. The generator 112 may be configured to generate the stream FILLVID in response to at least one of the stream VIDIN and the stream CONVID. In one example, the media stream FILLVID may be compressed and encoded (or encrypted). In another example, the media stream FILLVID may be clear (i.e., directly viewable).

The combiner 114 may have an input 140 that may receive the media stream CONVID, an input 142 that may receive the media stream FILLVID and an output 144 that may present the media stream VIDOUT. The combiner 114 is generally configured to generate the media stream VIDOUT in response to the media stream CONVID and the media stream FILLVID.

In one example, the generator 112 may generate the stream FILLVID as a single or, alternatively, multiple I-frames without interleaving P and B frames until the stream has caught up to the reference broadcast or multicast video stream CONVID. The I-frames may be implemented with a lower resolution or frame rate than the reference video stream CONVID. The lower resolution or frame rate generally reduces or minimizes bandwidth requirements and encoding complexity.

In another example, the generator 112 may generate the stream FILLVID as an abbreviated (i.e., optimal, reduced content, shortened, etc.) I, P, and B frame combination that may provide a viewable picture instead of a black image, and may further have synchronized timing such that the reference stream CONVID may be seamlessly viewed when the next succeeding conventional GOP is transmitted by the media processor 100.

In one example, the stream FILLVID may be transmitted via a multi-cast on network addresses that are known by the video service provider to desire one or more of the advantages of the present invention (i.e., reduced or eliminated black screen images during channel changing). The appropriate receiving device (e.g., a set top box (STB), a viewing device, etc.) may receive and play back the signal FILLVID during the channel change process until a conventional GOP stream (e.g., the stream CONVID) is available to generate a screen image.

In another example, The stream FILLVID may comprise frames that are transmitted at a rate that is higher than transmission rate of the stream CONVID. The stream VIDOUT may be transmitted via a unicast process. The stream FILLVID may provide video content that a decoder in the receiving device (e.g., the STB, the viewing device, etc.) may receive and play back to “catch up” the viewed image during rapid channel changing such that a black screen image is eliminated or the display time of the a black screen image is reduced when compared to conventional approaches. The appropriate receiving device (e.g., the STB, the viewing device, etc.) may receive and play back the signal FILLVID during the channel change process until a conventional GOP stream (e.g., the stream CONVID) is available (i.e., has “caught up”) to generate a whole screen image.

In the case where a media stream is sent to a receiver via a unicast transmission (including but not limited to on-demand content) receivers may be up to one “GOP” off of each other. E.g., when switching streams, the image to be viewed may be started at the beginning of the current GOP structure. A unique ‘synchronizing’ GOP may be generated (e.g., the stream FILLVID may be generated) and sent (e.g., broadcast, presented, transmitted, etc.) at any time to bring the timing of the unicast stream into alignment with a reference broadcast or multicast stream, thereby allowing the image displayed to the user to join (i.e., be synchronized to) an existing or new multicast or broadcast session.

Instead of a ‘black’ screen between channel changes, the I frame at the ‘beginning’ of the next GOP may be sent substantially immediately and remain on screen until the reference video stream ‘catches up’ (i.e., is synchronized to) with the channel change. When users are ‘surfing’ (i.e., rapidly changing) channels, the I frames may be encoded to generate a media stream that fills in the gaps before staring the next GOP (i.e., the media stream FILLVID may be configured to emulate an analog channel changing video image display).

Referring to FIG. 1b, a diagram illustrating a media processor 100′ of the present invention is shown. The processor 100′ generally comprises a generator 112′ and the combiner 114. The processor 100′ may have an input that receives the media stream CONVID, an input that receives a signal (e.g., CNG) and an output that present the media stream VIDOUT. The signal CNG is generally implemented as a control signal. The processor 100′ may be configured to generate and present the media stream VIDOUT in response to the media stream CONVID and the signal CNG. The signal CNG generally comprises a signal that is presented in response to a user (e.g., viewer, customer, client, etc.) changing a channel that is viewed on at least one viewing device.

The generator 112′ may delete the input 130 that receives the video stream VIDIN. The generator 112′ may have an input 136 that receives the signal CNG. The media stream FILLVID may be selectively generated and transmitted. The selectively transmitted portion of the stream VIDOUT is generally transmitted in response to the signal CNG. The media stream FILLVID may be transmitted in response to client demand (e.g., “on demand”) when a channel change occurs (i.e., when the signal CNG is received by the processor 100′). The signal CNG may be a pulse. The media stream FILLVID may be transmitted for a predetermined time (e.g., T) in response to the signal CNG after the receipt of the signal CNG. After the time T has expired, the media stream FILLVID may be discontinued and the media stream VIDOUT may comprise the media stream CONVID.

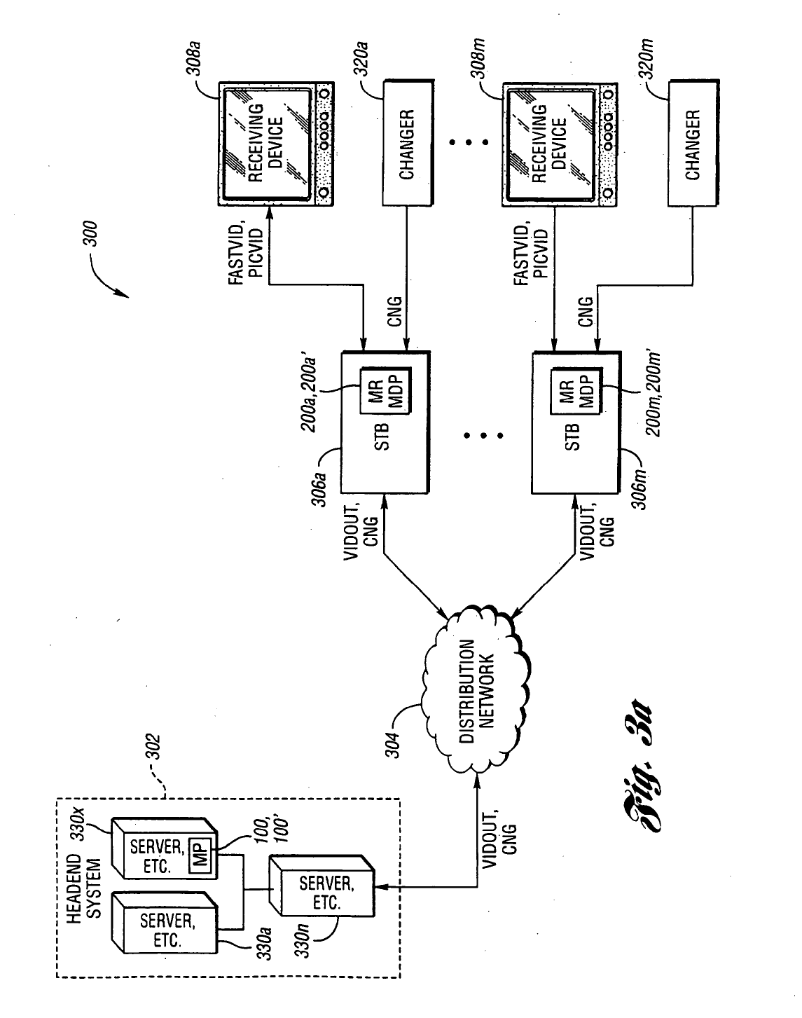

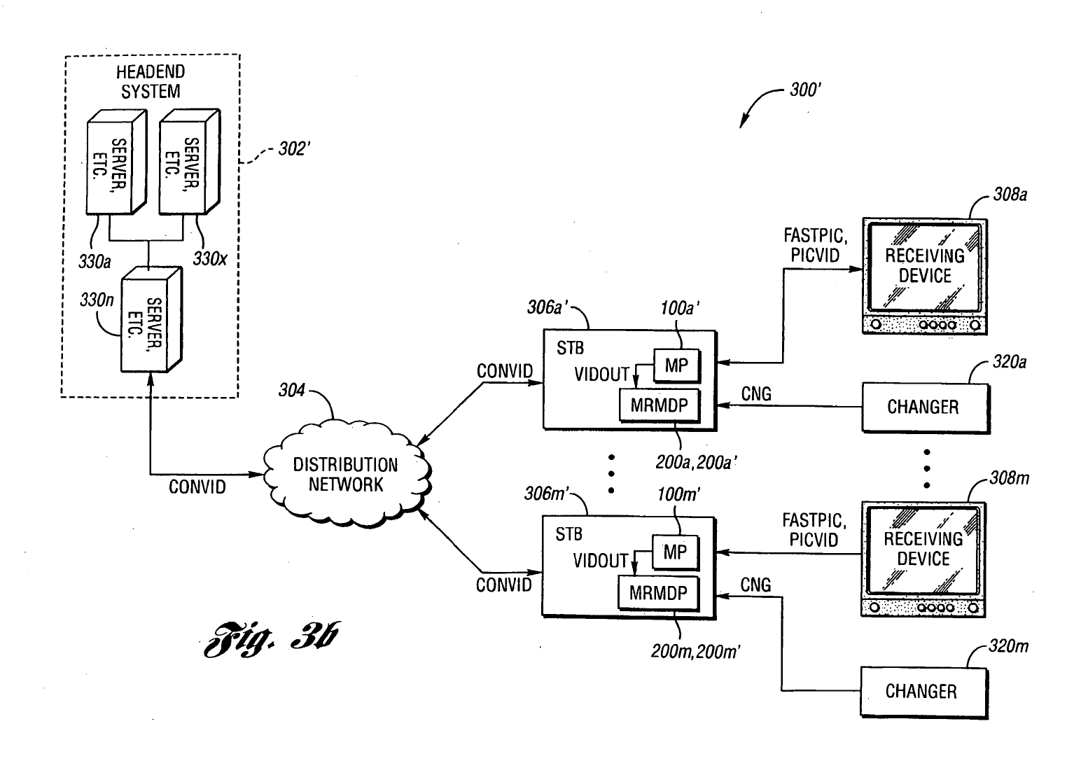

Referring to FIG. 2a, a diagram illustrating a multi-rate media decoding media processor 200 of the present invention is shown. The media processor 200 is generally configured to decode the media stream VIDOUT and generate a media stream that can be processed and displayed by a conventional digital television. The media processor 200 may have a first input that receives the media stream VIDOUT, a second input that receives the control signal CNG and an output that presents at least one media stream (e.g., a media stream FASTPIC and a media stream PICVID). The media processor 200 is generally configured to present either of the media stream FASTPIC and the media stream PICVID in response to the media stream VIDOUT and the control signal CNG.

The media stream FASTPIC is generally implemented as a decoded and decompressed media stream that is presented to a receiving device such that an image is displayed substantially immediately on the viewing screen of the receiving device during ‘channel surfing’ (i.e., rapid channel changing). In one example, the image that is displayed in response to the media stream FASTPIC may be implemented as a media stream that provides a partial image that has information sufficient to provide the user (viewer) the content of the channel that has been selected. In contrast, the media stream PICVID is generally implemented as a conventional decoded and decompressed media stream. When the media stream FILLVID is implemented as a clear media stream, the media stream FASTPIC may be implemented directly as the media stream FILLVID.

The processor 200 generally comprises a selector 210, a fast picture decoder 212 and a normal picture decoder 214. The selector 210 may have a first input that receives the media stream VIDOUT, a second input that receives the control signal CNG and two outputs (e.g., outputs 220 and 222) that present the media stream VIDOUT. The decoder 212 may have an input that is connected to the selector 210 via the output 220 and receives the media stream VIDOUT, and an output that presents the media stream FASTPIC (generally to a receiving and display device such as a television, monitor, etc.). The decoder 214 may have an input that is connected to the selector 210 via the output 222 and receives the media stream VIDOUT, and an output that presents the media stream PICVID (generally to a receiving and display device such as a television, monitor, etc.).

The selector 210 is generally implemented as a discriminator, timer and multiplexer apparatus (i.e., device, circuit, software module, and the like). The selector 210 generally selects (i.e., determines, senses, etc.) whether the media stream VIDOUT is presented to the decoder 212 or to the decoder 214 in response to the media stream VIDOUT and the control signal CNG. In another example, the 210 may select whether the media stream VIDOUT is presented to the decoder 212 or to the decoder 214 in response to a predetermined time (e.g., TT) between channel changes via operation of the timer in connection with receipt of the signal CNG.

In yet another example, the 210 may perform as a discriminator and select whether the media stream VIDOUT is presented to the decoder 212 or to the decoder 214 in response to the content of the media stream VIDOUT. The selector 210 may discriminate (i.e., determine, sense, etc. the type or format of) the content of the media stream VIDOUT. For example, when the media stream VIDOUT includes the media stream FILLVID, the selector 210 may present the media stream VIDOUT to the decoder 212 such that the media stream FASTPIC is presented to a viewing device. When the media stream VIDOUT includes only the media stream CONVID (i.e., the media stream FILLVID is not presented), the selector 210 may present the media stream VIDOUT to the decoder 212 such that the media stream PICVID is presented to a viewing device.

Referring to FIG. 2b, a diagram illustrating a multi-rate media decoding media processor 200′ of the present invention is shown. The media processor 200′ is generally implemented similarly to the processor 200. However, the processor 200′ may perform (i.e., operate, process, etc.) without receiving the control signal CNG. The processor 200′ generally comprises a selector 210′. The selector 210′ may delete the input that receives the control signal CNG.

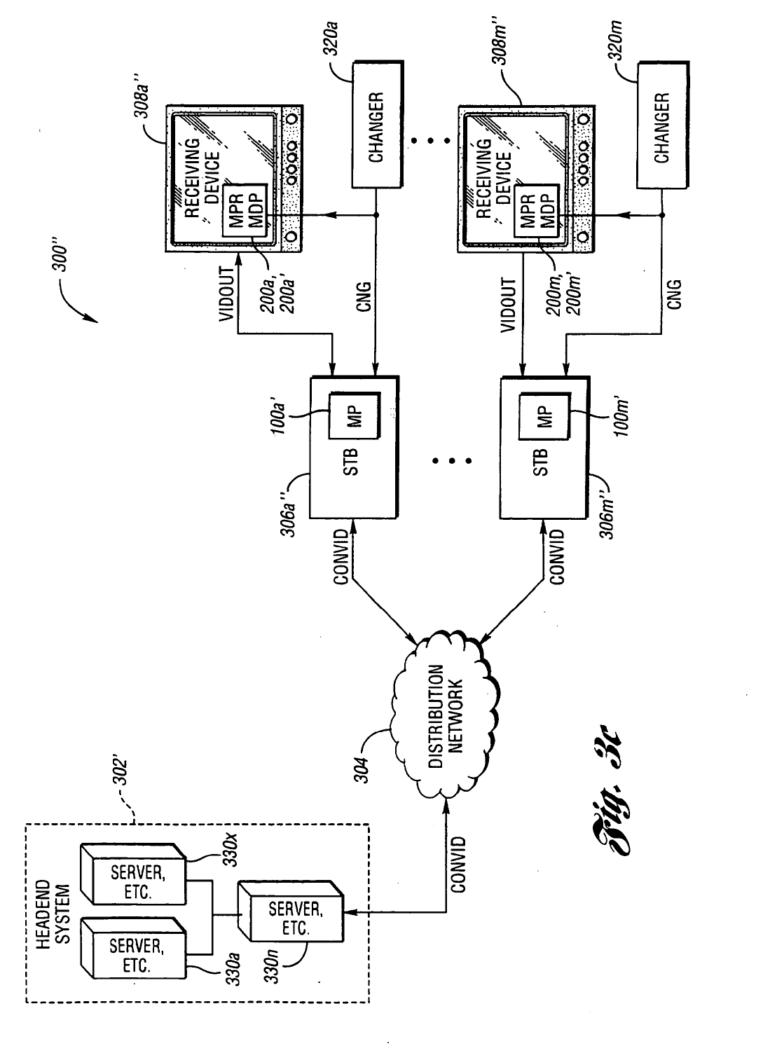

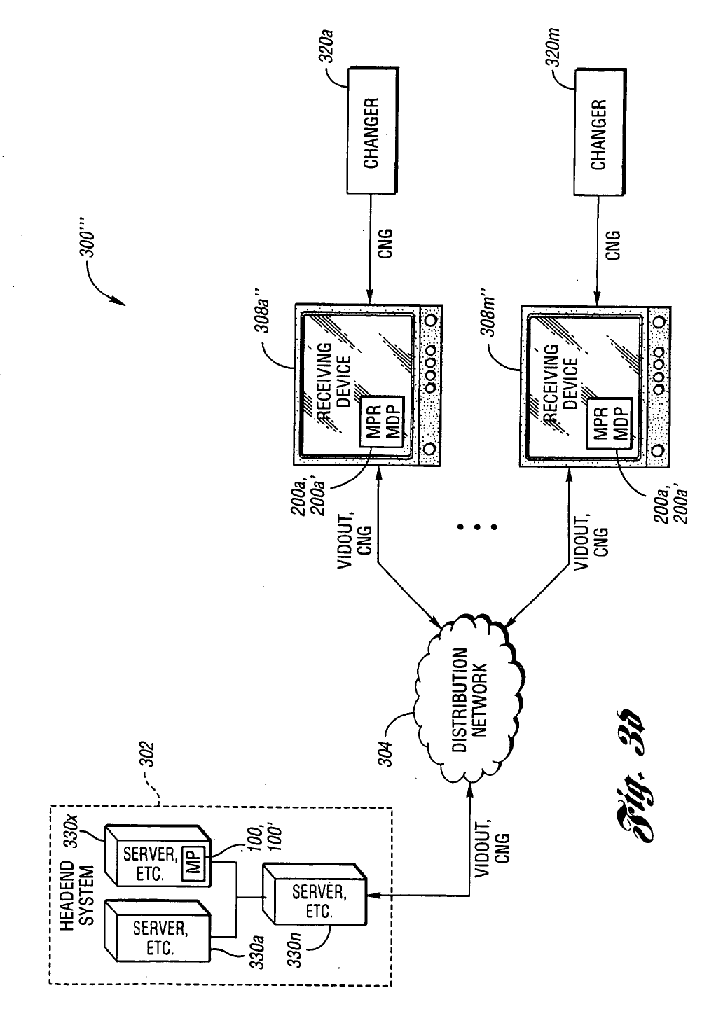

Referring to FIG. 3a, a diagram illustrating a media stream distribution system 300 including the present invention is shown. The distribution system 300 generally comprises a headend 302, a network 304, at least one set top box (STB) 306 (generally a plurality of STBs 306a-306m), at least one respective viewing device 308 (generally a plurality of viewing devices 308a-308m), and at least one respective channel change control device 320 (e.g., the devices 320a-320m).

The distribution system 300 is generally implemented as a television service provider/subscriber system wherein the provider (or vendor) generally operates the headend 302 and the network 304, and also provides a subscriber (i.e., client, customer, service purchaser, user, etc.) with the STB 306. The STB 306 is generally located at the subscriber location (not shown, e.g., home, tavern, hotel room, business, etc.) and the viewing device 308 is generally provided by the client. The viewing device 308 is generally implemented as a television, digital television (DTV), high definition television (HDTV), monitor, host viewing device, etc.

The headend 302 is generally electrically coupled to (i.e., in communication with) the network 304, the network 304 is generally electrically coupled to (i.e., in communication with) the STB 306, and the STB 306 is generally electrically coupled to (i.e., in communication with) the respective viewing device 308. The electrical coupling (or communication) may be implemented as any appropriate hard-wired (e.g., twisted pair, untwisted conductors, coaxial cable, fiber optic cable, hybrid fiber cable, etc.) or wireless (e.g., radio frequency, microwave, infrared, etc.) coupling and protocol (e.g., HomePlug, HomePNA, IEEE 802.11(a-b), Bluetooth, HomeRF, etc.) to meet the design criteria of a particular application. While the distribution system 300 is illustrated showing one viewing device 308 coupled to a respective one STB 306, each STB 306 may be implemented having the capability of coupling more than one viewing device 308 (not shown).

The headend 302 generally comprises a plurality of devices 330 (e.g. devices 330a-330n) that are implemented as data servers, computers, processors, security encryption and decryption apparatuses or systems, and the like configured to provide video and audio data (e.g., movies, music, television programming, streaming media, data services, telephony/communication services, and the like), processing equipment (e.g., provider operated subscriber account processing servers), television service transceivers (e.g., transceivers for standard broadcast televison and radio, digital televison, HDTV, audio, MP3, text messaging, gaming, media streams, etc.), and the like.

One of the devices 330 (e.g., device 330x), may be implemented including, in one example, the media processor 100 as described above in connection with FIG. 1a, and, in another example, the media processor 100′ as described above in connection with FIG. 1b. In one example, the headend 302 may generate and present (i.e., transmit, provide, pass, broadcast, send, etc.) the media VIDOUT, and receive the signal CNG.

The network 304 is generally implemented as a media stream distribution network (e.g., cable, satellite, IP Data Network, and the like) that is configured to selectively distribute (i.e., transmit and receive) television service provider signals (e.g., standard broadcast televison and radio, digital televison, HDTV, audio, MP3, text messaging, media streams, etc.) for example, as the media stream VIDOUT to the STBs 306. The media VIDOUT is generally distributed based upon (or in response to) subscriber information. For example, the level of service the client has purchased (e.g., basic service, premium movie channels, etc.), the type of service the client has requested (e.g., standard TV, HDTV, interactive messaging, etc.), and the like may determine the media streams that are sent to a particular subscriber. The network 304 may receive the signal CNG from the STB 306 and present the signal CNG to the headend 302 (in particular to the processor 100).

The STB 306 is generally implemented as an STB having multiple media capability (e.g., standard broadcast televison and radio, digital televison, audio, MP3, high definition digital television (HDTV), text messaging, etc.). The STB 306 generally comprises at least one respective multi rate media decoding processor (e.g., in one implementation, the processor 200 as described in connection with FIG. 2a, and in another implementation, the processor 200′ as described in connection with FIG. 2b). The processor 200 may receive encrypted (and compressed) video and audio data (e.g., the media stream VIDOUT) and present clear video and audio data (e.g., as the media streams FASTPIC and PICVID) to the viewing device 308. The STB 306 may present the signal CNG to the media processor 100 via the network 304.

The device 320 is generally implemented as a channel changer (e.g., remote control, ‘clicker’, ‘remote’, etc.). The changer 320 generally transmits (e.g., broadcasts, sends, presents, etc.) the signal CNG (e.g., to the STB 306) when a user (not shown) wishes to change the channel that is to be viewed on a display screen of the receiving device 308.

Referring to FIG. 3b, a diagram illustrating a media stream processing and distribution system 300′ implemented in connection with the present invention is shown. The distribution system 300′ generally comprises a headend 302′, the network 304, at least one set top box (STB) 306′ (generally a plurality of STBs 306a′-306m′), at least one respective viewing device 308′ (generally a plurality of viewing devices 308a′-308m′), and the at least one respective channel change control device 320 (e.g., the devices 320a-320m).

The headend 302′ may generate and present (i.e., transmit, provide, pass, broadcast, send, etc.) the media stream CONVID to the STB 306′ via the network 304.

The STB 306′ may be implemented including a media processor (e.g., the media processor 100′ as described above in connection with FIG. 1b), and a multi rate media decoding processor (e.g., in one implementation, the processor 200 as described in connection with FIG. 2a, and in another implementation, the processor 200′ as described in connection with FIG. 2b). The media decoding processor 200 may be coupled to the processor 100′, and may receive encrypted (and compressed) video and audio data (e.g., the media stream VIDOUT) and present clear video and audio data (e.g., as the media streams FASTPIC and PICVID) to the viewing device 308.

Referring to FIG. 3c, a diagram illustrating a media stream processing and distribution system 300″ implemented in connection with the present invention is shown. The distribution system 300″ generally comprises the headend 302′, the network 304, at least one set top box (STB) 306″ (generally a plurality of STBs 306a″-306m″), at least one respective viewing device 308″ (generally a plurality of viewing devices 308a″-308m″), and the at least one respective channel change control device 320 (e.g., the devices 320a-320m).

The STB 306″ may be implemented including a media processor (e.g., the media processor 100′ as described above in connection with FIG. 1b). The STB 306 generally receives the media stream CONVID from the network 304 and the control signal CNG from the changer 320, and presents the media stream VIDOUT to the receiving device 308″.

The receiving device 308″ generally includes a multi rate media decoding processor (e.g., in one implementation, the processor 200 as described in connection with FIG. 2a, and in another implementation, the processor 200′ as described in connection with FIG. 2b). The media decoding processor 200 may receive encrypted (and compressed) video data (e.g., the media stream VIDOUT) and the control signal CNG, and generate and clear video data (e.g., as the media streams FASTPIC and PICVID) that is displayed on the viewing screen of the receiving device 308″.

Referring to FIG. 3d, a diagram illustrating a media stream processing and distribution system 300′″ implemented in connection with the present invention is shown. The distribution system 300′″ generally comprises the headend 302, the network 304, and at least one of the receiving device (i.e., receiver, transceiver, etc.) 308″ (generally a plurality of the devices 308a″-308m″). The receiving device 308″ is generally coupled directly to the network 304 (i.e., the system 300′″ is generally implemented without STBs such as the STB 306). The receiving device 308″ generally receives the media stream VIDOUT from the network 304 and the signal CNG from the changer 320, and presents the signal CNG to the media processor 100 via the network 304.

In yet another example (not shown), the system 300′″ may be implemented having at least one STB 306 coupled to the network 304 and with at least one receiver 308 coupled thereto, as well as having at least one receiving device 308″ that is directly coupled to the network 304.

In various embodiments and respective modes of operation, the present invention may provide for at least one of: insertion of at least one I frame into a unicast transmission, sending at least one I frame on demand (i.e., in response to a user command) via IP or other networking technologies (i.e., in connection with a switched broadcast), multicasting a stream of I frames that a STB can “grab” (i.e., receive and decode) on known multicast addresses, constantly maintaining up-to-date I frames in the headend, transmitting ‘burst’ frames (e.g., frames that are broadcast at a higher than normal rate) on unicast streams to ‘catch up’ the decoder, and (in connection with a unicast transmission) providing for the viewing devices to be a GOP off (e.g., holding and displaying a previous image) and starting the display that is viewed with an I frame.

The various modes of operation are generally implemented via continuous generation and transmission of the media stream FILLVID in connection with the media processor 100, intermittent transmission of the media stream FILLVID in response to the signal CNG in connection with the media processor 100′, and decoding and decompressing the media stream VIDOUT via the multi-rate media processors 200 and 200′. The media processor 100, the media processor 100′, and the multi-rate media processors 200 and 200′ as illustrated and described above generally comprise a media processing sub-system that is configured to provide for substantially immediately displaying a user viewable image on a display screen of a media stream receiving device (e.g., device 308) during channel changing.

As is readily apparent from the foregoing description, then, the present invention generally provides an improved system and an improved method using new and innovative systems and techniques for fast channel changes in digital media systems that reduces or eliminates the brief black screen images that are sometimes encountered on digital television systems during the channel changing process.

While embodiments of the invention have been illustrated and described, it is not intended that these embodiments illustrate and describe all possible forms of the invention. Rather, the words used in the specification are words of description rather than limitation, and it is understood that various changes may be made without departing from the spirit and scope of the invention.

What is claimed is:

1. A system for processing digital media streams, the system comprising:
a headend configured to generate the digital media streams;
a network in communication with the headend and configured to receive the digital media streams;
at least one set top box (STB) in communication with the network and configured to receive the digital media streams and present at least one of the digital media streams and a decoded version of at least one of the digital media streams; and
at least one receiving device in communication with a respective at least one STB to receive at least one of the digital media streams, wherein at least one of the headend, the at least one STB, and the receiving device comprises a media processing sub-system configured to receive at least one of the digital media streams and to provide for substantially immediately displaying a user viewable image on a display screen of the receiving device during channel changing.

2. The system of claim 1 wherein at least one of the media streams comprises a group of pictures and at least one I frame, and at least one other of the media streams is a media stream that provides the substantially immediately viewable image.

3. The system of claim 2 wherein at least one of the media streams is in a compressed digital format media stream including a Motion Pictures Expert Group (MPEG) media stream including at least one of MPEG-1, MPEG-2, MPEG-4, and Windows Media 9 and Real Media.

4. The system of claim 2 wherein the media processing sub-system continuously generates and transmits the at least one other media stream.

5. The system of claim 2 wherein the system further comprises a changer configured to present a channel change control signal, and the media processing sub-system intermittently transmits the at least one other media stream in response to the control signal.

6. The system of claim 2 wherein the at least one other media stream comprises at least one I frame inserted into a unicast transmission.

7. The system of claim 2 wherein the at least one other media stream comprises at least one I frame that is sent in response to a user demand via an Internet protocol network in a switched broadcast.

8. The system of claim 2 wherein the at least one other media stream comprises a stream of I frames that are multicast to known multicast addresses via the network.

9. The system of claim 2 wherein the at least one other media stream comprises frames that are broadcast at a higher rate than the at least one media stream on a unicast transmission.

10. The system of claim 2 wherein the media processing sub-system is implemented in connection with a unicast transmission to provide for holding and displaying a previous image as the at least one other media stream, and displaying the at least one media stream when a first I frame is available.

11. A method of processing digital media streams, the method comprising:
generating digital media streams at a headend;
coupling a network to the headend and receiving the digital media streams at the network;
coupling at least one set top box (STB) to the network and receiving the digital media streams at the at least one STB; and
coupling at least one respective receiving device configured to receive at least one of the digital media streams or a decoded version of at least one of the digital media streams to the at least one STB, wherein at least one of the headend, the at least one STB, and the at least one receiving device comprises a media processing sub-system configured to provide for substantially immediately displaying a user viewable image on a display screen of the receiving device during channel changing.

12. The method of claim 11 wherein at least one of the media streams comprises a group of pictures and at least one I frame, and at least one other of the media streams is a media stream that provides the substantially immediately viewable image.

13. The method of claim 12 wherein at least one of the media streams is a Motion Pictures Expert Group (MPEG) media stream including at least one of MPEG-1, MPEG-2 and MPEG-4, and Windows Media 9 and Real Media.

14. The method of claim 12 wherein the media processing sub-system continuously generates and transmits the at least one other media stream.

15. The method of claim 12 further comprising presenting a channel change control signal using a changer, and intermittently transmitting the at least one other media stream in response to the control signal.

16. The method of claim 12 wherein the at least one other media stream comprises at least one I frame inserted into a unicast transmission.

17. The method of claim 12 wherein the at least one other media stream comprises at least one I frame that is sent in response to a user demand via an Internet protocol network in a switched broadcast.

18. The method of claim 12 wherein the at least one other media stream comprises a stream of I frames that are multicast to known multicast addresses via the network.

19. The method of claim 12 wherein the at least one other media stream comprises frames that are broadcast at a higher rate than the at least one media stream on a unicast transmission.

20. The method of claim 12 wherein the sub-system is implemented in connection with a unicast transmission to provide for holding and displaying a previous image as the at least one other media stream, and displaying the at least one media stream when a first I frame is available.

21. For use in a system for multi-stream digital media processing, a media processing sub-system, the sub-system comprising:
a media processor configured to generate and present digital media streams, wherein at least one of the media streams comprises a group of pictures and at least one I frame, and at least one other of the media streams is a media stream that provides a substantially immediately viewable image on a display screen of a receiving device during channel changing; and
a multi-rate media decoding processor configured to decode the MPEG media stream and the at least one other media stream.

22. The sub-system of claim 21, wherein the sub-system is implemented in connection with at least one of a headend, at least one set top box (STB), and the receiving device that comprise the system for multi-stream digital media processing.

23. The sub-system of claim 21, wherein at least one of the media streams is in a compressed digital format media stream including a Motion Pictures Expert Group (MPEG) media stream including at least one of MPEG-1, MPEG-2, MPEG-4, and Windows Media 9 and Real Media.
